(19) United States
(12) Patent Application Publication
(10) Pub. No.: US 2016/0286843 A1
(43) Pub. Date: Oct. 6, 2016

(54) DYNAMIC METHOD FOR PARTIAL OR TOTAL REMOVAL OF ORGANOHALOGENATED COMPOUNDS CONTAINED IN DRINKS, NOTABLY WINE

(71) Applicants: IFP ENERGIES NOUVELLES, Rueil-Malmaison Cedex (FR); VECT'OEUR, Beaune Cedex (FR)

(72) Inventors: Michel THOMAS, LYON (FR); Michel MARTIN, LYON (FR); Jessica DRINKINE-MAGNEUX, MERCEUIL (FR); Eric BORNERT, SAVIGNY LES BEAUNES (FR); Gérard MICHEL, QUETIGNY (FR)

(21) Appl. No.: 15/035,920

(22) PCT Filed: Oct. 28, 2014
(86) PCT No.: PCT/EP2014/073105

§ 371 Date: May 11, 2016

(30) Foreign Application Priority Data
Nov. 12, 2013 (FR) 13 61009

(51) Int. Cl. A23L 2/80; C12H 1/056

(52) U.S. Cl. CPC A23L 2/80; C12H 1/0424; A23V 2002/00

(57) ABSTRACT

The present invention relates to a method for removing toxic or unwanted polyhalogenated compounds from drinks, said method comprising a stage of contacting the drink with an adsorbent containing a polymeric material.

According to the invention, the contacting stage consists in circulating the drink in a column containing said adsorbent.

### FIELD OF THE INVENTION

The present invention relates to a dynamic method for partial or total removal of unwanted or toxic compounds contained in drinks, notably wine.

It more particularly relates to the removal of polyhalogenated compounds contained in wine.

Over the past years, measures restricting or prohibiting the use and marketing of an increasingly large number of chemical compounds, in particular pesticides and other treatment products, have been regularly taken. This is essentially due to the high toxicity and to the effect thereof on consumers' health.

This is the case with pentachlorophenol (PCP), a molecule used as a wood preservative product and as a disinfectant, an herbicide, a termiticide and anti-blue paint. This compound and its manufacturing by-products (essentially 2,3,4,6-tetrachlorophenol (TeCP)) are highly toxic to humans and animals.

Similarly, lindane (1,2,3,4,5,6-hexachlorocyclohexane) is also a toxic compound in widespread use as an insecticide, notably for soil and wood treatment.

Another polybrominated phenolic compound, 2,4,6-tribromophenol (TBP), is furthermore increasingly used as a flame retardant, a fungicide and/or a wood preservative. Its toxicity is comparatively lower than that of PCP or other brominated flame retardants, which are subject to measures of prohibition. However, its increasing use will cause greater consumer exposure and, as part of the precautionary principle, it is important to reduce this exposure to the maximum.

Such restrictive measures concerning the production and use of these polyhalogenated toxic compounds will have a short-term effect, but the materials treated with such products are however going to remain.

Furthermore, as has already been observed with DDT for example, significant residual traces of these compounds will be found for many years in products intended for human consumption, due to the stability of these compounds and to the persistence thereof in food chains.

This is all the more important for the wine industry, considering the four sources of contamination identified for wine.

The first source is the cork that releases 2,4,6-trichloroanisole (TCA) and 2,4,6-trichlorophenol (TCP) in bottled wines.

However, some wines can have a musty corky taste prior to any contact with a cork. The use of chlorinated biocides or of highly chlorinated water from the distribution network leads to the formation of TCP upon contact with phenolic compounds of wine, wood, cork or some resins used for coating floors and tanks.

The use of wood fungicide and insecticide treatment products has introduced pentachlorophenol (PCP), 2,3,4,6-tetrachlorophenol (TeCP) and lindane in wine storehouses through pallet boxes, frames, doors, etc.

Finally, the presence of 2,4,6-tribromophenol (TBP) is mainly due to its use as anti-fungal wood treatment and as a flame retardant for many materials (insulators, plastics).

All these molecules are highly volatile and they are airborne contamination vectors for wines and the winery equipment present in wineries. This generates cross-contaminations that amplify, disseminate and perpetuate the pollution process.

Besides, in the field of wine, removal of haloanisoles is a major problem. These compounds, in particular 2,4,6-trichloroanisole (TCA), 2,3,4,6-tetrachloroanisole (TeCA) and 2,4,6-tribromoanisole (TBA), are the compounds mainly responsible for the “corky taste” of wine. Their removal leads to the disappearance of these bad smells and bad tastes, and it allows to rediscover the initial sensory qualities of a wine. Haloanisoles mainly originate from the o-methylation of the corresponding halophenols, an essentially microbiological process: 2,4,6-trichloroanisole (TCA)/2,6-trichlorophenol (TCP), 2,3,4,6-tetrachloroanisole (TeCA)/2,3,4,6-tetrachlorophenol (TeCP), penta-chloroanisole (PCA)/pentachlorophenol (PCP), and tribromoanisole (TBA)/tribromophenol (TBP).

Furthermore, removal of the unwanted compounds that fall into the category of pesticides (PCP, lindane, etc.) allows compliance of the wines, considering a probable evolution of the standards on phytosanitary residues, so as to get closer to the standards currently in force regarding drinking water, which serve as a reference (0.1 μg/L (microgram/liter) in pesticide cumulative amount according to French decree No. 2001-1220 of 20 Dec. 2001).

Besides, removal of these compounds needs to be done without affecting the organoleptic properties of the wines treated, i.e. by avoiding modifying the aromatic pool of the wine considered. This is essential in order to comply with the regulations in force as regards wine appellations and to obtain approval from the relevant authorities.

Finally, implementation of the method will, for the same reasons, need not to disturb the winemaking process and be economically reasonable.

### BACKGROUND OF THE INVENTION

It is already well known, notably from Spanish patent ES-2,195,784, to remove chloroanisoles and chlorophenols by dipping a cling film, preferably a low-density polyethylene film, in the wine to be treated, previously transferred into an aseptic vessel.

A similar teaching is provided by patent WO-2006/024,767 filed by the applicant. The tests conducted with low-density polyethylene (LDPE) have allowed to reduce by more than fifty per cent the proportion of the main compounds concerned (PCP, TCP, TCA and lindane) in the treated wines. The LDPE used in these tests comes in form of a 16/1000 millimeter-thick film. The contact time was 24 hours with a surface area ranging between 6 and 10 m² per hectoliter.

Furthermore, U.S. Pat. No. 4,276,179 discloses a method for removing halogenated hydrocarbons, notably DDT and polychlorinated biphenyls, from aqueous media by bringing the liquid to be treated in contact with a polyolefinic adsorbent. The adsorbent consists of a polymer selected from among ethylene, propylene, polytrimethylbutene and polymethylpentene homopolymers, as well as copolymers of these compounds.

Patent EP-1,283,864 relates to a method for suppressing unpleasant flavours in wine through contact with ultra-high molecular weight polyethylene (HDPE), substituted or not with acid and hydroxide groups. The method consists in filtering the wine on a bed of adsorbent granules around 120 μm in size, at the rate of 150 g polymer per liter of wine. The proportion of TCA is thus significantly reduced.

U.S. Pat. No. 8,057,671 relates to the use of dealuminated zeolites of Si/Al ratio above 5, and notably of faujasite structure, for removing TCA from wine. These zeolites are used as powder mixed with the wine, which subsequently requires a filtration stage to separate them from the treated liquid.

The prior art methods described above involve significant drawbacks.

Indeed, they require either long contact times between the drink and the polymer, or large amounts of polymer per liter of drink, and above all they are impractical to implement.

The present invention thus aims to solve the aforementioned drawbacks more efficiently than the prior art, with a method for removing toxic or unwanted polyhalogenated compounds from drinks, comprising a stage of contacting the drink to be treated with an adsorbent consisting of a synthetic polymeric material using a dynamic process.

### SUMMARY OF THE INVENTION

The present invention thus relates to a method for removing toxic or unwanted polyhalogenated compounds from drinks, said method comprising a stage of contacting the drink with an adsorbent containing a polymeric material, characterized in that the contacting stage consists in circulating the drink in a column containing said adsorbent.

The method can consist in using a column of cylindrical geometry whose length/inside diameter ratio (L/D) is greater than 0.25 and preferably greater than 1.

The method can consist in using a column whose L/D ratio ranges between 2 and 50, preferably between 2 and 10.

The contacting stage can be carried out over a period of less than 6 hours, preferably less than 3 hours.

The contacting stage can be carried out over a period of less than 1 hour, preferably less than 30 minutes, or more preferably less than 15 minutes.

The superficial velocity of flow of the liquid drink in the column can be preferably less than 1 m/min, more preferably less than 0.25 m/min.

The method can consist in regenerating the adsorbent so as to re-use it in a new drink treatment cycle.

The method can consist in regenerating the adsorbent in dynamic mode by circulating through the column containing said material a regeneration solution causing desorption of the polyhalogenated compounds of the adsorbent.

The method can consist in regenerating the adsorbent by circulating through the column containing said material a stream of water, of ethanol, or of a water/ethanol mixture.

The method can consist in carrying out an adsorbent sterilization stage after the regeneration stage.

The method can consist in using an adsorbent with a proportion of non-aliphatic polymer below 60%.

The method can consist in using a homopolymer, linear or branched, as the adsorbent.

The method can consist in using a copolymer as the adsorbent.

The method can consist in using a mixture of aliphatic and/or non-aliphatic polymers as the adsorbent.

The method can consist in using an adsorbent resulting from the melting of a mixture of aliphatic and/or non-aliphatic polymers.

The aliphatic monomers can be selected from among: ethylene, propylene, butylene, acrylonitrile, methyl methacrylate, ketones, and the non-aliphatic monomers are selected from among: ethylene terephthalate, ethylene naphthalate, methylene terephthalate, propylene terephthalate, butylene terephthalate, styrene.

The aliphatic polymer can be selected from the group: low-density polyethylene, low-density linear polyethylene, polypropylene, polyacrylonitrile, poly(methyl methacrylate) and polyketones, and the non-aliphatic polymer is selected from the group: poly(ethylene terephthalate), poly(ethylene naphthalate), poly(methylene terephthalate), poly(propylene terephthalate), poly(butylene terephthalate), polystyrene, poly(styrene-co-acrylonitrile).

The degree of crystallinity of the polymer(s) can be less than 60% and preferably less than 45%.

The grain size of the adsorbent can range between 50 μm and 5 mm, preferably between 150 μm and 5 mm.

The present invention also relates to an application of the method to the treatment of wine, water, fruit juice, beer or alcohols.

Other features and advantages of the invention will be clear from reading the detailed description hereafter.

### DETAILED DESCRIPTION

According to an essential stage of the method of the invention, the drink to be treated is contacted with an adsorbent consisting of a polymeric material shaped as granules and placed in a column within which the drink to be treated circulates.

The grain size of the material is thus larger, which affords the advantage of creating less pressure drops upon passage of the drink to be treated.

Drinks are understood to be in particular drinks intended for human consumption, such as wine.

The granules are, for example, more or less spherical balls, or cylindrical extrudates, some millimeters long to the maximum, typically less than 2 cm and preferably less than 1 cm. The characteristic diameter of these objects ranges for example between 2 and 5 mm, advantageously between, 0.5 and 2 mm. Smaller objects can also be used, for example those whose grain size typically ranges between 50 and 500 μm, or between 150 and 500 μm.

The polymeric material according to the invention is advantageously a homopolymer, linear or branched, resulting from the polymerization of a single monomer.

The polymeric material is alternatively a copolymer resulting from the copolymerization of at least two monomer types as conventionally known, and it is thus of alternating, statistical or block copolymer type.

This material also results from subsequent combinations of two or more polymers, such as a graft copolymer obtained through grafting by chain polymerization of a polymer on a first polymeric substrate, or from the melting of a mixture of aliphatic and non-aliphatic polymer particles for example.

In a first example of the invention, the adsorbent used is a copolymer.

The aliphatic monomers are selected from the group: ethylene, propylene, butylene, acrylonitrile, methyl methacrylate, ketones. Lower alkyls are preferably used.

The non-aliphatic monomers are selected from among: ethylene terephthalate, ethylene naphthalate, methylene terephthalate, propylene terephthalate, butylene terephthalate, styrene.

In a second example, the adsorbent results from the melting of a mixture of aliphatic and/or non-aliphatic polymer particles.

In a third example of the invention, the adsorbent consists of an aliphatic homopolymer, linear or branched.

In a fourth example, the adsorbent consists of a mixture of adsorbents from Examples one to three.

The aliphatic polymer is preferably selected from among polyethylene in its various low-density polyethylene (LDPE), linear low-density polyethylene (LLDPE) forms.

Polypropylene (PP), polyacrylonitrile, poly(methyl methacrylate) or polyketones can also be used. Low-density polyethylene (LDPE) is preferably used.

The non-aliphatic polymer, i.e. with aromatic groups in the structure thereof, is selected among polyesters such as poly(ethylene terephthalate) (PET), poly(ethylene naphthalate) (PEN), poly(methylene terephthalate), poly(propylene terephthalate) (PPT) or poly(butylene terephthalate), polystyrene or poly(styrene-co-acrylonitrile) (SAN).

Advantageously, the proportion of non-aliphatic polymer in the adsorbent is less than 60 mass %.

For cost and ease of production reasons, preference is given to binary compositions, i.e. those comprising one aliphatic polymer type and one non-aliphatic polymer type.

Of course, ternary or quaternary adsorbents combining one or more aliphatic types and at least one non-aliphatic type can be used within the context of the invention.

The preferred formulations for the adsorbent according to the invention are selected from the group: LDPE/PET, PP/PET, PP/PPT, LDPE/PP.

Advantageously, the adsorbent has a semi-crystalline structure, with a degree of crystallinity below 60%, preferably below 45%.

Indeed, the looser the crystal lattice of the polymer, the easier the diffusion of the molecules adsorbed at the surface of the adsorbent through the thickness thereof, thus allowing to remove more toxic or unwanted molecules. This degree of crystallinity can for example be determined with the differential scanning calorimetry (DSC) technique by comparison with reference samples.

Besides, the polymers used are food grade polymers.

According to an important stage of the invention, the adsorbent is placed in a column wherein the drink to be treated is circulated so as to provide minimum contact time between the drink and the polymer in order to notably reduce the proportion of unwanted molecules such as halophenols and haloanisoles.

Advantageously, the column is arranged vertically in a preferred embodiment of the invention so as to promote contact between the liquid and the polymer, and to prevent liquid channelling, for example in the column wall area.

The drink can circulate downward (downflow) or upward (upflow) in the column.

An upflow circulation, from the bottom of the column to the top, is preferably provided.

The liquid flow rate is so adjusted to ensure minimum contact time with the solid within the column. Advantageously, the contact time between the drink and the solid adsorbent in the column is less than 6 hours and preferably less than 3 hours. More preferably yet, it is typically less than 1 hour, or less than 30 minutes, or less than 15 minutes.

The total amount of adsorbent to be contacted and the duration of the contact time with the drink can be easily optimized by the person skilled in the art depending on the initial proportion of toxic or unwanted compounds in the drink to be treated.

For indication only, it has been possible for example to treat a volume of wine whose total haloanisole content is 38 nanograms per liter (ng/L), equivalent to about 50 times the volume of the column containing the adsorbent solid, with a contact time of 15 minutes.

The column in which the solid is arranged preferably has a cylindrical geometry whose L/D ratio (length/inside diameter) is greater than 0.25 and preferably greater than 1. Preferably, it ranges between 2 and 50, more preferably between 2 and 10.

In order to ensure sufficient contact time between the liquid to be treated and the solid adsorbent, the superficial velocity (“empty” column) of flow of the liquid drink in the column is preferably less than 1 meter per minute (m/min) and more preferably less than 0.25 m/min. Expressed in terms of liquid hourly space velocity or LHSV (defined as the ratio of the liquid flow rate to the empty column volume), this corresponds to values below 25 m³/m³/h and preferably below 10 m³/m³/h.

According to the volumes of liquid to be treated, it is of course possible to use several columns arranged in series and/or in parallel.

Another advantage of the method is that the polymeric material used can be easily regenerated in order to be re-used in a new treatment cycle, thus allowing substantial savings in adsorbent material.

This regeneration stage can also be preferably carried out in dynamic mode by circulating in the column containing said material a stream of regeneration solution that causes desorption of the compounds, notably of halophenol and haloanisole type, of the polymeric material. This regeneration solution can consist of water or of a hydroalcoholic solution such as, for example, a water/ethanol (food grade) mixture, or ethanol (food grade).

The regeneration solution used for this regeneration type is free to the maximum from traces of chlorine, chlorinated alkaline compounds and halogenated compounds that may either decrease the regeneration efficiency or increase the pollutant load of the liquid resulting from the regeneration, which needs to be depolluted in a subsequent stage. It must also meet the antibacterial standards in force.

Prior treatment of the regeneration solution used for regenerating the polymeric material can be achieved according to the conventional procedures known to the person skilled in the art. For example, an extemporaneous treatment of water and/or ethanol on activated carbon is carried out in order to remove all traces of chlorine, bromine, chlorinated alkaline compounds and organohalogenated compounds in the water.

Advantageously, this regeneration stage is performed at a temperature ranging between ambient temperature and 100° C., preferably between ambient temperature and 50° C.

A maximum temperature that causes no significant degradation of the polymer properties, such as its degree of crystallinity for example, or no significant variations in the transition temperatures, determined among others by DSC, is notably selected.

The volume of the regeneration solution to be used for regeneration ranges between 5 and 100 times the volume of the column containing the polymeric material, preferably between 10 and 50 times this volume.

A polymeric material sterilization stage is a sine qua non for microbiological stability of the polymeric material for future use.

An organohalogenate-free sterilization method causing no significant degradation of the polymer properties, such as its degree of crystallinity for example, or no significant variations in the transition temperatures, determined for example by DSC, is preferably selected.

For example, a peracetic acid solution ranging between 200 and 350 ppm can be used. The static or dynamic contact time can be easily optimized by the person skilled in the art depending on the implementation conditions. A stage of rinsing with previously treated water is then carried out until complete removal of the disinfecting agent by pH control.

The regeneration solution, not including the sterilization stage, which leaves the column is likely to contain, in the dissolved state, all or part of the halogenated compounds, and notably the halophenols and haloanisoles desorbed from the polymer.

In order to limit the amount of solution required or to limit discharge to the environment, it is possible to treat this regeneration solution in order to totally or at least partly remove these dissolved halogenated compounds and to re-use, optionally in a closed circuit, this solution thus treated in the regeneration stage so as to limit the total amount of water to be used.

Another advantage is to limit possibly any airborne contamination of the ambient air by these halogenated compounds, which can in turn further contaminate the drinks to be treated.

Treatment of this regeneration solution contaminated by the chlorinated compounds can be achieved for example according to two routes.

The first route consists in circulating directly this liquid solution on a filter containing a suitable adsorbent for capturing in the liquid phase the halogenated compounds.

The second route consists in using a buffer tank where the regeneration solution is contacted with a gas stream made up of air or of an inert gas such as nitrogen for example so as to carry along all or part of the dissolved halogenated compounds in this gas, then in treating this gas laden with halogenated compounds on a filter containing a suitable adsorbent for capturing in the gas phase the halogenated compounds. Advantageously, a system allowing better gas/liquid contact such as, for example, bubbling through a small pore size sintered material, or any system providing high dispersion of the gas bubbles in the liquid, is then used.

Non-limitative examples of adsorbent solids capable of adsorbing halogenated compounds, notably halophenols and haloanisoles, are preferably hydrophobic solids such as activated carbon, polymeric resins such as, for example, polystyrene-divinylbenzene type resins, or molecular sieves or zeolites, preferably those of faujasite type with a Si/Al ratio above 2.4 and preferably above 5. These solids are preferably used as granules, balls or extrudates whose grain size ranges for example between 50 μm and 5 mm, preferably between 150 μm and 5 mm.

In case of optional re-use in a closed circuit of the regeneration solution, it is advisable to check the microbiological stability of the solution over time. Setting up a sterilizing filtration system coupled or not with a UV lamp to remove microorganisms from the regeneration solution is recommended. Regular control of the food contact parameters of the solution is necessary.

With the method described above, the proportions of the various aromatic compounds in the wine have undergone little or no changes, in any case not organoleptically perceptible upon tasting. Furthermore, no trace of wine contamination by compounds from the adsorbent has been observed.

If the adsorbents according to the invention are particularly efficient as regards halophenols and haloanisoles, it is readily admitted, in comparison with the prior art, that they also have an impact on other toxic polyhalogenated compounds that may be present in the treated wines, such as for example polychlorobromophenols and the residues of organochlorinated phytosanitary products.

Furthermore, it is easy to understand that this method particularly applicable to the treatment of wines can be readily transposed to other drinks intended for human consumption, notably fruit juices, water, beer or strong alcohols.

The applicants have carried out tests as described in the examples below, with a wine-based drink, which have allowed to show selective adsorption of the target compounds, notably the aforementioned halophenols and haloanisoles, without any perceptible changes to the aromatic pool and to the organoleptic properties of the wine treated.

It is understood that the examples of implementation of the method according to the invention are particular cases given by way of non limitative example of the invention.

### EXAMPLE 1

A “blank” test was first conducted with an empty column and without adsorbent material in order to check the absence of parasitic halophenol and haloanisole adsorption on the line or column walls.

Column characteristics:
column length: 50 cm
column diameter: 2 cm
column volume: 157 cm³
wine flow rate: 500 cm³/h
wine contact time in the empty column: 19 minutes.

About 3 liters (L) wine were used in this test, which represents approximately 19 empty column volumes. Wine samples were regularly taken over time in order to determine the proportions of haloanisoles (HA), halophenols (HP) and lindane (HCH) by gas chromatography.

Prior to circulating the wine within the column, the total initial proportion of HP in the wine was 51.5 ng/L, the HA proportion was 39.1 ng/L and the HCH proportion was 7.6 ng/L.

After passage of the wine through the empty column, these proportions were respectively 51.0 ng/L, 38.6 ng/L and 7.6 ng/L.

No significant variation in these proportions was thus observed in the absence of adsorbent in the column.

### EXAMPLE 2

A first batch of wine contamined with halophenols (HP), haloanisoles (HA) and lindane (HCH) was treated through passage in a column filled with polyethylene (LDPE) balls of average diameter in the 3.5-4.5 mm range, under the following conditions:
column length: 50 cm
column diameter: 2 cm
column volume: 157 cm³
PE mass: 90 g
wine flow rate: 250 cm³/h
wine/LDPE contact time: 15 minutes.

The degree of crystallinity of the polymer, determined by DSC, was 35%.

The volume of wine treated was 8000 cm³, which is equivalent to about 50 volumes of (empty) column. Wine samples were taken regularly over time in order to determine the proportions of HA, HP and HCH by gas chromatography.

The total initial proportion of HP in the wine was 55.2 ng/L, the HA proportion was 35.5 ng/L and the HCH proportion was 10.8 ng/L.

After treatment by passage through the LDPE-containing column, these proportions were respectively 41.0 ng/L, 2.1 ng/L and 8.5 ng/L. The corresponding removal rates thus were 25%, 94% and 21% respectively.

### EXAMPLE 3

A second batch of wine contamined with halophenols (HP), haloanisoles (HA) and lindane (HCH) was treated under the same conditions in a column filled with balls made from the same polyethylene (LDPE), of average diameter in the 3.5-4.5 mm range.

The volume of wine treated was 15,000 cm³, which is equivalent to about 90 volumes of (empty) column. Wine samples were taken regularly over time in order to determine the proportions of HA, HP and HCH by gas chromatography.

The total initial proportion of HP in the wine was 173.7 ng/L, the HA proportion was 74.6 ng/L and the HCH proportion was 9.5 ng/L.

After treatment, these proportions were respectively 153.2 ng/L, 7.8 ng/L and 7.9 ng/L. The corresponding removal rates thus were 12%, 89% and 17% respectively.

It can be noted that, during these tests, the proportion of the various aromatic compounds in the wine had hardly changed and no trace of wine contamination by compounds from the adsorbent was observed.

1. A method for removing toxic or unwanted polyhalogenated compounds from drinks, said method comprising a stage of contacting the drink with an adsorbent containing a polymeric material, characterized in that the contacting stage consists in circulating the drink in a column containing said adsorbent.

2. A method as claimed in claim 1, characterized in that it consists in using a column of cylindrical geometry whose length/inside diameter ratio (L/D) is greater than 0.25 and preferably greater than 1.

3. A method as claimed in claim 1, characterized in that it consists in using a column whose L/D ratio ranges between 2 and 50, preferably between 2 and 10.

4. A method as claimed in claim 1, characterized in that the contacting stage is carried out over a period of less than 6 hours, preferably less than 3 hours.

5. A method as claimed in claim 4, characterized in that the contacting stage is carried out over a period of less than 1 hour, preferably less than 30 minutes, or more preferably less than 15 minutes.

6. A method as claimed in claim 1, characterized in that the superficial velocity of flow of the liquid drink in the column is preferably less than 1 m/min, more preferably less than 0.25 m/min.

7. A method as claimed in claim 1, characterized in that it consists in regenerating the adsorbent so as to re-use it in a new drink treatment cycle.

8. A method as claimed in claim 7, characterized in that it consists in regenerating the adsorbent in dynamic mode by circulating through the column containing said material a regeneration solution causing desorption of the polyhalogenated compounds of the adsorbent.

9. A method as claimed in claim 8, characterized in that it consists in regenerating the adsorbent by circulating through the column containing said material a stream of water, of ethanol, or of a water/ethanol mixture.

10. A method as claimed in claim 7, characterized in that it consists in carrying out an adsorbent sterilization stage after the regeneration stage.

11. A method as claimed in claim 1, characterized in that it consists in using an adsorbent with a proportion of non-aliphatic polymer below 60%.

12. A method as claimed in claim 1, characterized in that it consists in using a homopolymer, linear or branched, as the adsorbent.

13. A method as claimed in claim 1, characterized in that it consists in using a copolymer as the adsorbent.

14. A method as claimed in claim 1, characterized in that it consists in using a mixture of aliphatic and/or non-aliphatic polymers as the adsorbent.

15. A method as claimed in claim 1, characterized in that it consists in using an adsorbent resulting from the melting of a mixture of aliphatic and/or non-aliphatic polymers.

16. A method as claimed in claim 1, characterized in that the aliphatic monomers are selected from among: ethylene, propylene, butylene, acrylonitrile, methyl methacrylate, ketones, and the non-aliphatic monomers are selected from among: ethylene terephthalate, ethylene naphthalate, methylene terephthalate, propylene terephthalate, butylene terephthalate, styrene.

17. A method as claimed in claim 1, characterized in that the aliphatic polymer is selected from the group: low-density polyethylene, low-density linear polyethylene, polypropylene, polyacrylonitrile, poly(methyl methacrylate) and polyketones, and the non-aliphatic polymer is selected from the group:
poly(ethylene terephthalate), poly(ethylene naphthalate), poly(methylene terephthalate), poly(propylene terephthalate), poly(butylene terephthalate), polystyrene, poly(styrene-co-acrylonitrile).

18. A method as claimed in claim 1, characterized in that the degree of crystallinity of the polymer(s) is less than 60% and preferably less than 45%.

19. A method as claimed in claim 1, characterized in that the grain size of the adsorbent ranges between 50 μm and 5 mm, preferably between 150 μm and 5 mm.

20. Application of the method as claimed in claim 1 to the treatment of wine, water, fruit juice, beer or alcohols.
